(19) United States
(12) Patent Application Publication
(10) Pub. No.: US 2021/0208608 A1
(43) Pub. Date: Jul. 8, 2021

(54) CONTROL METHOD, CONTROL APPARATUS, CONTROL TERMINAL FOR UNMANNED AERIAL VEHICLE

(71) Applicant: SZ DJI TECHNOLOGY CO., LTD., Shenzhen (CN)

(72) Inventors: Canlong LIN, Shenzhen (CN); Jian FENG, Shenzhen (CN); Xianghua JIA, Shenzhen (CN)

(21) Appl. No.: 17/211,358

(22) Filed: Mar. 24, 2021

Related U.S. Application Data
(63) Continuation of application No. PCT/CN2018/110624, filed on Oct. 17, 2018.

(30) Foreign Application Priority Data
Sep. 30, 2018 (CN) 201811159461.8

(51) Int. Cl. G05D 1/10; G05D 1/00; B64C 39/02

(52) U.S. Cl. CPC G05D 1/106; G05D 1/0038; B64C 2201/127; B64C 2201/146; B64C 39/024

(57) ABSTRACT

A control method includes providing an image on a display device where the image is an image of an environment captured by a photographing apparatus provided at an unmanned aerial vehicle, determining a position of a selected point in the image in response to a point selection operation on the image by a user, and generating a waypoint for the unmanned aerial vehicle or marking an obstacle within the environment according to the position of the selected point in the image.

### CROSS-REFERENCE TO RELATED APPLICATIONS

This application is a continuation of International Application No. PCT/CN2018/110624, filed Oct. 17, 2018, which claims priority to Chinese Application No. 201811159461.8, filed Sep. 30, 2018, the entire contents of both of which are incorporated herein by reference.

### TECHNICAL FIELD

The present disclosure relates to the technical field of control technology and, more particularly, to a control method, control apparatus, and control terminal for unmanned aerial vehicle.

### BACKGROUND

In existing technologies, to determine a waypoint for an unmanned aerial vehicle or to mark an obstacle in the environment where the unmanned aerial vehicle is located, the following three methods are mainly used:

(1) Hold a control terminal of the unmanned aerial vehicle and walk around an operation area to complete the planning of the operation area, and then the waypoint for the unmanned aerial vehicle to move within the operation area is generated according to the operation area. When the operation area is large, the efficiency of this method for generating the waypoint is very low, which is inconvenient for high-efficiency operation.

(2) Control the unmanned aerial vehicle to move to an ideal position of a waypoint or a position of an obstacle, to perform a real-time marking. However, in this way, the unmanned aerial vehicle is required to perform extra operation, which wastes the energy of the unmanned aerial vehicle. In addition, for some obstacles, the unmanned aerial vehicle may not be able to move to the positions of the obstacles for marking.

(3) Use a dedicated surveying and mapping unmanned aerial vehicle to mark waypoints or obstacles. However, users need to purchase additional surveying and mapping unmanned aerial vehicle, which increases the operation cost.

It can be seen that in the existing technologies, the method of generating waypoints or marking obstacles in the environment where the unmanned aerial vehicle is located is not convenient enough, which will reduce the operation efficiency of the unmanned aerial vehicle.

### SUMMARY

In accordance with the disclosure, there is provided a control method including providing an image on a display device where the image is an image of an environment captured by a photographing apparatus provided at an unmanned aerial vehicle, determining a position of a selected point in the image in response to a point selection operation on the image by a user, and generating a waypoint for the unmanned aerial vehicle or marking an obstacle within the environment according to the position of the selected point in the image.

Also in accordance with the disclosure, there is provided a control apparatus including a display device and a processor. The processor is configured to provide an image on the display device where the image is an image of an environment captured by a photographing apparatus provided at an unmanned aerial vehicle, determine a position of a selected point in the image in response to a point selection operation on the image by a user, and generate a waypoint for the unmanned aerial vehicle or mark an obstacle within the environment according to the position of the selected point in the image.

### BRIEF DESCRIPTION OF THE DRAWINGS

In order to explain the technical solutions in the embodiments of the present disclosure more clearly, reference is made to the accompanying drawings, which are used in the description of the embodiments. Obviously, the drawings in the following description are some embodiments of the present disclosure, and other drawings can be obtained from these drawings without any inventive effort for those of ordinary skill in the art.

FIG. 1 shows a schematic architectural diagram of an unmanned aerial vehicle system according to an embodiment of the present disclosure.

FIG. 2 shows a schematic flow chart of a control method according to an embodiment of the present disclosure.

FIG. 3 is a schematic diagram showing point selection on an image by a user according to an embodiment of the present disclosure.

FIG. 4 is a schematic side view of an unmanned aerial vehicle during flight according to an embodiment of the present disclosure.

FIG. 5 is a schematic top view of the unmanned aerial vehicle during flight according to an embodiment of the present disclosure.

FIG. 6 is a schematic diagram showing a field of view of a photographing apparatus according to an embodiment of the present disclosure.

FIG. 7 is a schematic diagram showing determination of a horizontal deviation angle and a vertical deviation angle according to an embodiment of the present disclosure.

FIG. 8 is a schematic diagram showing a photographing apparatus mounted at a vehicle body of an unmanned aerial vehicle according to an embodiment of the present disclosure.

FIG. 9 is a schematic diagram showing a direction of a reference point relative to an unmanned aerial vehicle in a vertical direction according to an embodiment of the present disclosure.

FIG. 10 shows a structural diagram of a control apparatus according to an embodiment of the present disclosure.

### DETAILED DESCRIPTION OF THE EMBODIMENTS

The technical solutions in the embodiments of the present disclosure will be clearly described with reference to the accompanying drawings. Obviously, the described embodiments are only some of rather than all the embodiments of the present disclosure. Based on the described embodiments, all other embodiments obtained by those of ordinary skill in the art without inventive effort shall fall within the scope of the present disclosure.

It should be noted that when a component is referred to as being “fixed to” another component, it can be directly attached to the other component or an intervening component may also exist. When a component is considered to be “connected” to another component, it can be directly connected to the other component or an intervening component may exist at the same time.

Unless otherwise defined, all technical and scientific terms used herein have the same meaning as commonly understood by those skilled in the technical field of the present disclosure. The terms used in the description of the present disclosure herein are for the purpose of describing specific embodiments only and are not intended to limit the present disclosure. The term “and/or” as used herein includes any and all combinations of one or more listed items associated.

Hereinafter, some embodiments of the present disclosure will be described in detail with reference to the accompanying drawings. In the case of no conflict, the following embodiments and features in the embodiments can be combined with each other.

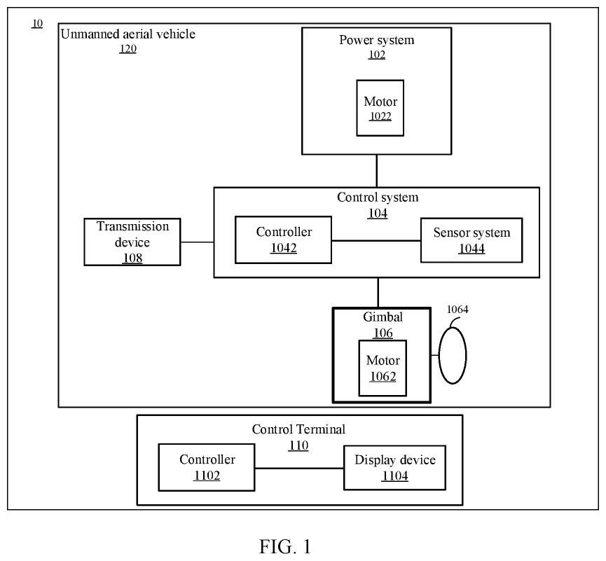

FIG. 1 is a schematic architectural diagram of an unmanned aerial vehicle system 10 according to an embodiment of the present disclosure. The unmanned aerial vehicle system 10 includes a control terminal 110 and an unmanned aerial vehicle 120. The unmanned aerial vehicle 120 may be a single-rotor or multi-rotor unmanned aerial vehicle.

The unmanned aerial vehicle 120 includes a power system 102, a control system 104, and a vehicle body. In some embodiments, the unmanned aerial vehicle 120 is a multi-rotor unmanned aerial vehicle, the vehicle body may include a center frame and one or more arms connected to the center frame, where the arms extend radially from the center frame. The unmanned aerial vehicle may also include a stand connected to the vehicle body and configured for supporting the unmanned aerial vehicle when the unmanned aerial vehicle is landed.

The power system 102 includes one or more motors 1022 used to provide power to the unmanned aerial vehicle 120, and the power enables the unmanned aerial vehicle 120 to make movement with one or more degrees of freedom.

The control system 104 includes a controller 1042 and a sensor system 1044. The sensor system 1044 is used to measure the status information of the unmanned aerial vehicle 120 and/or the information of the environment in which the unmanned aerial vehicle 120 is located. The status information may include attitude information, position information, remaining power information, etc. The information of the environment may include depth, air pressure, humidity, temperature of the environment, and so on. The sensor system 1044 may include, for example, at least one of sensors such as a barometer, a gyroscope, an ultrasonic sensor, an electronic compass, an inertial measurement unit, a vision sensor, and a global navigation satellite system receiver. For example, the global navigation satellite system may be a global positioning system (GPS).

The controller 1042 is used to control various operations of the unmanned aerial vehicle. For example, the controller 1042 can control the movement of the unmanned aerial vehicle. As another example, the controller 1042 can control the sensor system 1044 of the unmanned aerial vehicle to collect data.

In some embodiments, the unmanned aerial vehicle 120 includes a photographing apparatus 1064 which can be a device for capturing images, such as a camera or a video camera. The photographing apparatus 1064 can communicate with the controller 1042 and take pictures under the control of the controller 1042. The controller 1042 can also control the unmanned aerial vehicle 120 according to the pictures taken by the photographing apparatus 1064.

In some embodiments, the unmanned aerial vehicle 120 also includes a gimbal 106 used to carry the photographing apparatus 1064. The gimbal 106 includes a motor 1062, and the controller 1042 may control the movement of the gimbal 106 through the motor 1062. It is understood that the gimbal 106 may be independent of the unmanned aerial vehicle 120 or may be a part of the unmanned aerial vehicle 120. In some embodiments, the photographing apparatus 1064 may be fixedly connected to the body of the unmanned aerial vehicle 120.

The unmanned aerial vehicle 120 also includes a transmission device 108. Under the control of the controller 1042, the transmission device 108 can send data collected by the sensor system 1044 and/or the photographing apparatus 1064 to the control terminal 110. The control terminal 110 may include a transmission device (not shown) which can establish a wireless communication connection with the transmission device 108 of the unmanned aerial vehicle 120.

The transmission device of the control terminal may receive data sent by the transmission device 108. In addition, the control terminal 110 can send a control instruction to the unmanned aerial vehicle 120 through the transmission device thereof.

The control terminal 110 includes a controller 1102 and a display device 1104. The controller 1102 can control various operations of the control terminal. For example, the controller 1102 may control the transmission device of the control terminal 110 to receive the data sent by the unmanned aerial vehicle 120 through the transmission device 108. As another example, the controller 1104 may control the display device 1104 to display the received data, where the data may include images of the environment captured by the photographing apparatus 1064, attitude information, position information, power information, etc.

It is understood that the controller described may include one or more processors which may work individually or cooperatively.

It is understood that the naming for each components of the unmanned aerial vehicle system described above is for identification purposes only rather than being a limitation to the embodiments of the present disclosure.

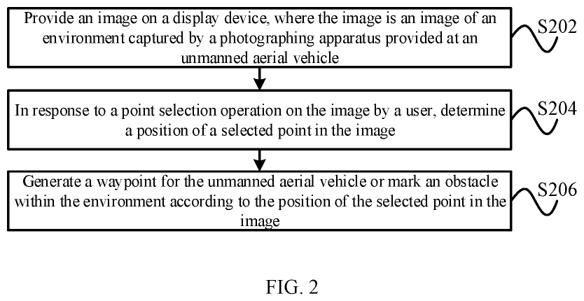

The embodiments of the present disclosure provide a control method. FIG. 2 is a flow chart of the control method according to an embodiment of the present disclosure. The control method shown in FIG. 2 can be implemented by a control apparatus. The control apparatus may be a component of the control terminal, that is, the control terminal can include the control apparatus. In some cases, some of the components of the control apparatus may be arranged at the control terminal, and some of the components may be arranged at the unmanned aerial vehicle. The control apparatus can include a display device which may be a touch display device. As shown in FIG. 2, the method includes the following processes.

S202, providing an image on a display device, where the image is an image of the environment captured by the photographing apparatus provided at the unmanned aerial vehicle.

As described above, the unmanned aerial vehicle is equipped with a photographing apparatus, which can collect images of the environment where the unmanned aerial vehicle is located when the unmanned aerial vehicle is in a stationary or moving state. The unmanned aerial vehicle can establish a wireless communication connection with the control apparatus and can send the images to the control apparatus through the wireless communication connection. After the control apparatus receives the images, it can be displayed on the display device.

S204, in response to a point selection operation on the image by a user, determining the position of the selected point in the image.

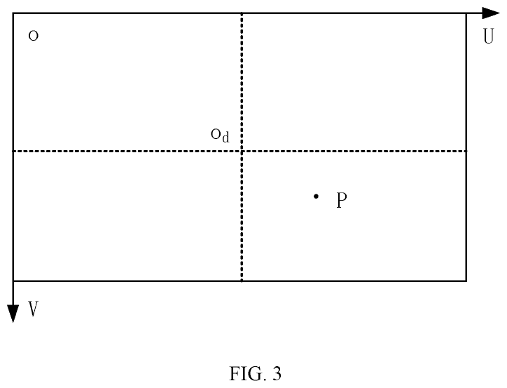

Specifically, the display device can show the user the image of the environment captured by the photographing apparatus of the unmanned aerial vehicle. When the user wants to set a certain point in the environment shown in the image as a waypoint, or when the user wants to mark an obstacle in the environment shown in the image, the user can perform a point selection operation on the image, such as clicking on the image display device showing the image. Referring to FIG. 3, if the user selects point P on the image, the control apparatus can detect the point selection operation of the user and determine the position of the point selected by the user in the image. The position of point P selected by the user in the image may be the position in the image coordinate system OUV, or the position of point P relative to the image center O_{d}, which is not specifically defined here.

S206, generating a waypoint for the unmanned aerial vehicle or marking an obstacle within the environment according to the position of the selected point in the image.

Specifically, after the position of the selected point in the image is obtained, when the user wants to set a certain point in the environment shown in the image as a waypoint, the control apparatus can generate the waypoint for the unmanned aerial vehicle according to the position of the point in the image. When the user wants to mark an obstacle in the environment shown in the image, the control apparatus can mark the obstacle in the environment where the unmanned aerial vehicle is located according to the position of the point in the image.

In the control method consistent with the present disclosure, the user selects a point on the image taken by the unmanned aerial vehicle, determines the position of the selected point in the image, and generates the waypoint for the unmanned aerial vehicle or mark the obstacles in the environment according to the position of the selected point in the image. In this way, the user can set the waypoints for the unmanned aerial vehicle and/or mark the obstacles in the environment where the unmanned aerial vehicle is located by directly marking on the image, which can effectively improve the operation efficiency and provide users with a new way of setting waypoints and marking obstacles.

In some embodiments, the method further includes generating a route according to the waypoints and controlling the unmanned aerial vehicle to fly according to the route. Specifically, the control apparatus may generate the route of the unmanned aerial vehicle according to the generated waypoints. The user can select multiple points in the image, and the control apparatus can generate multiple waypoints according to the positions of the multiple points in the corresponding image and then generate a route according to the multiple waypoints. The control apparatus can control the unmanned aerial vehicle to fly according to the route. In some cases, the control apparatus can send the generated route to the unmanned aerial vehicle through the wireless communication connection, and the unmanned aerial vehicle can fly according to the received route.

In some embodiments, the method further includes controlling the unmanned aerial vehicle to avoid the marked obstacles during the flight of the unmanned aerial vehicle. Specifically, the control apparatus can determine the obstacles in the environment after the obstacles are marked. In the process of controlling the flight of the unmanned aerial vehicle, the control apparatus can control the unmanned aerial vehicle to avoid the marked obstacles, to prevent the unmanned aerial vehicles from hitting obstacles.

In some embodiments, the method further includes generating a route that avoids the obstacles according to the marked obstacles and controlling the unmanned aerial vehicle to fly according to the route. Specifically, the control apparatus can determine the obstacles in the environment after marking the obstacles. For example, the environment may be a farmland with obstacles, and the unmanned aerial vehicle needs to perform spray operation on the farmland. The control terminal can generate a route to avoid the obstacles in the farmland after the obstacles are marked, and can control the unmanned aerial vehicle to fly according to the route. When the unmanned aerial vehicle flies according to the route, it will not hit obstacles and hence the operation safety is ensured.

In some embodiments, generating the waypoint of the unmanned aerial vehicle or marking the obstacle in the environment according to the position of the selected point in the image includes: determining the position information of the waypoint of the unmanned aerial vehicle according to the position of the selected point in the image, and generating the waypoint of the unmanned aerial vehicle according to the position information of the waypoint, or, determining the position information of the obstacle in the environment according to the position of the selected point in the image, and marking the obstacle in the environment according to the position information of the obstacle.

Specifically, before the waypoint of the unmanned aerial vehicle is generated, the position information of the waypoint needs to be determined. After obtaining the position of the point in the image, the control apparatus can determine the position of the waypoint according to the position of the point in the image, where the position of the waypoint may be a two-dimensional position (such as longitude and latitude) or a three-dimensional position (such as longitude, latitude, and altitude).

Similarly, before the obstacle in the environment where the unmanned aerial vehicle is located is marked, the position information of the obstacle in the environment needs to be determined. After obtaining the position of the point in the image, the control apparatus can determine the position information of the obstacle according to the position of the point in the image, where the position information of the obstacle may be a two-dimensional position (such as longitude and latitude) or a three-dimensional position (such as longitude, latitude, and altitude).

In some embodiments, determining the position information of the waypoint of the unmanned aerial vehicle or the obstacle in the environment according to the position of the selected point in the image includes: determining the direction of a reference point in the environment relative to the unmanned aerial vehicle according to the position of the selected point in the image, determining the position information of the reference point according to the direction and the position information of the unmanned aerial vehicle, and determining the position information of the waypoint of the unmanned aerial vehicle or the obstacle in the environment according to the position information of the reference point.

Specifically, after obtaining the position of the point in the image, the control apparatus can determine the direction of the reference point relative to the unmanned aerial vehicle, i.e., determining in which direction the reference point is with respect to the unmanned aerial vehicle, on in another word, determining an orientation of a line connecting the reference point and the unmanned aerial vehicle. The direction may include the direction of the reference point relative to the unmanned aerial vehicle in the horizontal direction (i.e., in the yaw direction) and the direction of the reference point relative to the unmanned aerial vehicle in the vertical direction (i.e., in the pitch direction). The reference point may be a position point obtained by projecting a point selected by the user in the image into the environment. In some embodiments, the reference point may be a position point obtained by projecting a point selected by the user in the image onto the ground in the environment. After the direction of the reference point relative to the unmanned aerial vehicle is obtained, the position information of the reference point can be determined according to the direction and the position information of the unmanned aerial vehicle. The position information of the unmanned aerial vehicle can be obtained by a position sensor arranged at the unmanned aerial vehicle, where the position sensor includes one or more of a satellite positioning system receiver, a vision sensor, and an observation measurement unit. The position information of the unmanned aerial vehicle may be two-dimensional position information (such as longitude and latitude) or three-dimensional position information (such as longitude, latitude, and altitude). The control apparatus can determine the position information of the waypoint or the obstacle according to the position information of the reference point once available. In some cases, the control terminal directly determines the position information of the reference point as the position information of the waypoint or obstacle. In some cases, the position information of the waypoint or the obstacle may be obtained from processed position information of the reference point.

In some cases, when the position of the reference point has three-dimensional position information (such as longitude, latitude, and altitude), the control apparatus can obtain two-dimensional position information (such as longitude and latitude) from the three-dimensional position information (such as longitude, latitude, and altitude), and determine the position information of the waypoint or obstacle according to the obtained two-dimensional position information.

Further, the determination of the position information of the reference point according to the direction and the position information of the unmanned aerial vehicle can be implemented in several feasible manners as follows.

In some embodiments, a relative height between the reference point and the unmanned aerial vehicle is determined, and the position information of the reference point is determined according to the relative height, the direction, and the position information of the unmanned aerial vehicle.

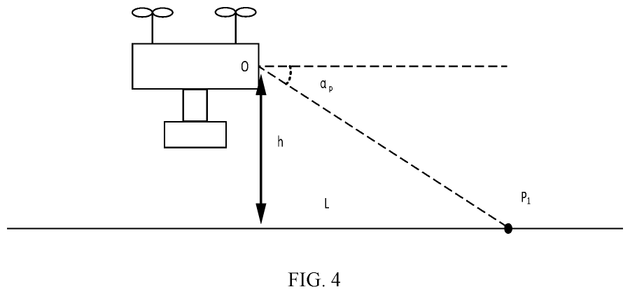

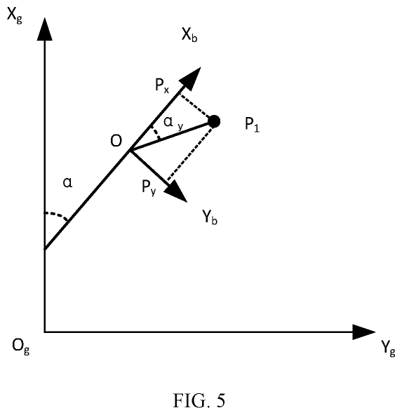

Specifically, as described above, the direction may include the direction of the reference point relative to the unmanned aerial vehicle in the horizontal direction (i.e., in the yaw direction) and the direction of the reference point relative to the unmanned aerial vehicle in the vertical direction (i.e., in the pitch direction). The unmanned aerial vehicle is equipped with an altitude sensor which can be one or more of a barometer, a vision sensor, and an ultrasonic sensor. The unmanned aerial vehicle may obtain a relative height between the reference point and the unmanned aerial vehicle using the altitude sensor, i.e., the relative height is determined according to the height information output by the altitude sensor carried by the unmanned aerial vehicle. In some embodiments, the ground height measured by the altitude sensor may be determined as the relative height between the unmanned aerial vehicle and the reference point. For example, as shown in a side view in FIG. 4, the center of mass of the unmanned aerial vehicle is O, and the relative height between the reference point and the unmanned aerial vehicle is determined to be h. According to the relative height h and the direction of the reference point relative to the unmanned aerial vehicle in the vertical direction αₚ, the horizontal distance between the reference point P₁ and the unmanned aerial vehicle is determined as L_{AP}=h/tan αₚ. In a top view in FIG. 5, the O_{g}X_{g}Y_{g} coordinate system is the ground coordinate system, where the coordinate origin O_{g} is the take-off point of the unmanned aerial vehicle, O_{g}X_{g} points to the north direction, and O_{g}Y_{g} points to the east direction; the coordinate system OX_{b}Y_{b} is a body coordinate system of the unmanned aerial vehicle, where OX_{b} points to the nose direction, and OY_{b} is perpendicular to OX_{b} and point to the right side of the vehicle body. It can be seen from the figure that, the horizontal distance in the OX_{b} direction between the unmanned aerial vehicle and the reference point, OPₓ, can be calculated according to the horizontal distance L_{AP} and the direction α_{y} of the reference point relative to the unmanned aerial vehicle in the horizontal direction, as follows:

OPₓ=L_{AP} cos α_{y}

Further, the horizontal distance in the OY_{b} direction between the unmanned aerial vehicle and the reference point, OP_{y}, can be calculated according to the horizontal distance L_{AP} and the direction α_{y} of the reference point relative to the unmanned aerial vehicle in the horizontal direction, as follows:

OP_{y}=L_{AP} sin α_{y}

The coordinate vector of the reference point P₁ in the XY plane of the vehicle body coordinate system can be represented as P_{b}=[P_{bx} P_{by} 0]=[L_{AP} cos α_{y} L_{AP} sin α_{y} 0].

The angle α between the vehicle body coordinate axis OX_{b} and the ground coordinate axis O_{g}X_{g} is the current yaw angle of the unmanned aerial vehicle, which can be obtained in real time by an attitude sensor (such as an inertial measurement unit) of the unmanned aerial vehicle. Thus, the coordinate conversion matrix from the vehicle body coordinate system to the ground coordinate system can be obtained as:

$${M}_{bg} = [ \begin{matrix}cos α & sin α & 0 \\ - sin α & cos α & 0 \\ 0 & 0 & 1\end{matrix} ]$$

Therefore, the projection vector P_{g} of the vector P_{b} in the ground coordinate system can be expressed as follows:

P_{g}=M_{bg}P_{b}=[P_{gx} P_{gy} 0]

The vector P_{g} is the offset vector of the position of the reference point relative to the position of the unmanned aerial vehicle in the ground coordinate system. The position information of the unmanned aerial vehicle, such as the longitude and latitude coordinates, can be obtained in real time by a position sensor. The longitude and latitude coordinates of the current position of the unmanned aerial vehicle are denoted as [φ_{c}, β_{c}], where φ_{c} is the longitude of the current position and β_{c} is the latitude of the current position.

From the longitude and latitude of the unmanned aerial vehicle and the offset vector P_{g} of the reference point P₁ relative to the current position, the position information of the reference point P₁, such as longitude φₚ and latitude βₚ, can be obtained by the following formulas:

$${ϕ}_{p} = {ϕ}_{c} + \frac{{P}_{gy}}{{r}_{e} cos {β}_{c}}$$

$${β}_{p} = {β}_{c} + \frac{{P}_{gx}}{{r}_{e}}$$

where rₑ is the average radius of the earth, which is known.

In some embodiments, the horizontal distance between the reference point and the unmanned aerial vehicle is obtained, and the position information of the reference point is determined according to the horizontal distance, the direction, and the position information of the unmanned aerial vehicle.

Specifically, in some cases, refer to FIGS. 4 and 5 again, the unmanned aerial vehicle may determine the horizontal distance L_{AP} between the reference point and the unmanned aerial vehicle. For example, the horizontal distance L_{AP} may be determined by a depth sensor carried by the unmanned aerial vehicle. The depth sensor can obtain depth information of the environment, and may include a binocular vision sensor, a time-of-flight (TOF) camera, etc. A depth image can be obtained by the depth sensor. After the user selects a point on the image output by the photographing apparatus, the selected point is projected onto the depth image according to the attitude and/or the mounting position relationship between the depth sensor and the photographing apparatus. The depth information of the point in the depth image obtained by the projection is determined as the horizontal distance L_{AP} between the reference point and the unmanned aerial vehicle. After the horizontal distance L_{AP} is obtained, the position information of the reference point can be determined according to the solution described above.

In some embodiments, determining the direction of the reference point relative to the unmanned aerial vehicle according to the position of the selected point in the image includes: determining the direction of the reference point relative to the unmanned aerial vehicle according to the position of the selected point in the image and the attitude of the photographing apparatus.

Specifically, as described above, the unmanned aerial vehicle is provided with a photographing apparatus which can be fixedly connected to the unmanned aerial vehicle, i.e., fixedly connected to the body of the unmanned aerial vehicle, or can be connected to the vehicle body of the unmanned aerial vehicle via a gimbal.

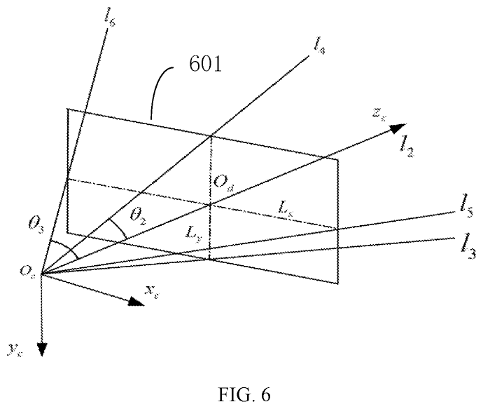

As shown in FIG. 6, O_{c}x_{c}y_{c}z_{c} is the body coordinate system of the photographing apparatus, where the axis O_{c}z_{c} is the center line direction of the photographing apparatus, i.e., the optical axis of the photographing apparatus. The photographing apparatus can photograph and capture an image 601, where O_{d} is the center of the image 601, and Lₓ and L_{y} are the distances from the center O_{d} of the image 601 to the left/right and upper/lower borders of the image 601, respectively. The distance may be expressed by the number of pixels. Lines l₃ and l₄ are the sight boundary lines of the photographing apparatus in the vertical direction, θ₂ is the sight angle of the photographing apparatus in the vertical direction. Lines l₅ and l₆ are the sight boundary lines of the photographing apparatus in the horizontal direction, θ₃ is the sight angle in the horizontal direction.

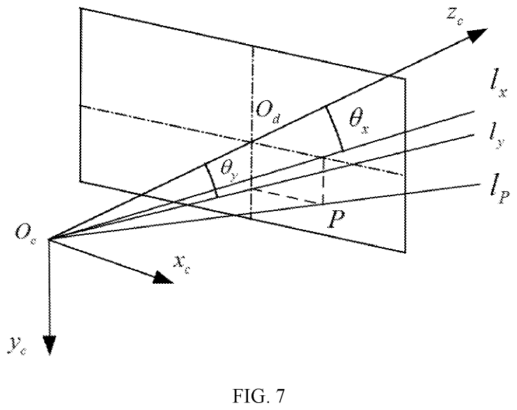

The control apparatus can obtain the attitude of the photographing apparatus, which can be the orientation of the optical axis O_{c}z_{c} of the photographing apparatus. As shown in FIG. 7, line lₚ is a straight line from the optical center O_{c} of the photographing apparatus to the point P selected by the user in the image. The reference point may be on the line lₚ. The reference point may be an intersection of the line lₚ and the ground in the environment of the unmanned aerial vehicle, and the orientation of the line lₚ may be the direction of the reference point relative to the unmanned aerial vehicle. The user selects different points in the image, and the orientation of the line lₚ is different, so that the angle of the direction of the reference point relative to the unmanned aerial vehicle deviating from the direction of the optical axis O_{c}z_{c} is also different, i.e., the direction of the reference point relative to the unmanned aerial vehicle differs from the attitude of the photographing apparatus. Therefore, the control apparatus can obtain the attitude of the photographing apparatus, and determine the direction of the reference point relative to the unmanned aerial vehicle according to the attitude of the photographing apparatus and the position of the point P in the image.

Further, determining the direction of the reference point relative to the unmanned aerial vehicle according to the position of the selected point in the image and the attitude of the photographing apparatus includes: determining an angle (deviation angle) by which the direction of the reference point relative to the unmanned aerial vehicle deviates from the attitude of the photographing apparatus according to the position of the selected point in the image, and determining the direction of the reference point relative to the unmanned aerial vehicle according to the angle and the attitude of the photographing apparatus.

Specifically, refer to FIG. 7 again, the angle by which the direction of the reference point relative to the unmanned aerial vehicle deviates from the attitude of the photographing apparatus can be determined according to the position of the selected point in the image (xₚ, yₚ). The deviation angle may include a deviation angle in the horizontal direction (i.e., in the yaw direction) and a deviation angle in the vertical direction (i.e., in the pitch direction). For convenience, the deviation angle in the horizontal direction (i.e., in the yaw direction) and the deviation angle in the vertical direction (i.e., in the pitch direction) are referred to as horizontal deviation angle and vertical deviation angle, respectively. The horizontal deviation angle θₓ and the vertical deviation angle θ_{y} are determined according to the position of the point P in the image, where θₓ and θ_{y} can be calculated using the following formulas:

$${θ}_{x} = \frac{{x}_{p} {θ}_{3}}{{L}_{x}}$$

$${θ}_{y} = \frac{{y}_{p} {θ}_{2}}{{L}_{y}}$$

Different from the image coordinate system shown in FIG. 3, in which the upper left corner point of the image is selected as the origin of the coordinate system, in the example corresponding to the above formulas, the origin of the image coordinate system is selected to be the center O_{d} of the image 601. As such, in the above formulas, the horizontal distance and vertical distance of the point P to the center O_{d} of the image 601 can be simply represented by the coordinate values xₚ and yₚ, respectively, of the point P in the image coordinate system.

After the angle by which the direction of the reference point relative to the unmanned aerial vehicle deviates from the attitude of the photographing apparatus is obtained, the direction of the reference point relative to the unmanned aerial vehicle can be determined according to the deviation angle and the attitude of the photographing apparatus. Further, as described above, the direction of the reference point relative to the unmanned aerial vehicle may include the direction of the reference point relative to the unmanned aerial vehicle in the horizontal direction and the direction of the reference point relative to the unmanned aerial vehicle in the vertical direction. The direction of the reference point relative to the unmanned aerial vehicle in the horizontal direction can be determined according to the horizontal deviation angle θₓ, and the direction of the reference point relative to the unmanned aerial vehicle in the vertical direction can be determined according to the vertical deviation angle θ_{y}.

Various implementations of determining the direction of the reference point relative to the unmanned aerial according to the angle by which the direction of the reference point relative to the unmanned aerial vehicle deviates from the attitude of the photographing apparatus and the attitude of the photographing apparatus are explained below with respect to different mounting conditions between the photographing apparatus and the unmanned aerial vehicle:

When the photographing apparatus is fixedly connected to the body of the unmanned aerial vehicle, the attitude of the photographing apparatus is determined according to the attitude of the unmanned aerial vehicle. For example, the photographing apparatus is mounted at the nose of the unmanned aerial vehicle. When the photographing apparatus is mounted at the nose of the unmanned aerial vehicle, the yaw attitude of the nose is consistent with the yaw attitude of the photographing apparatus, and the direction of the reference point relative to the unmanned aerial vehicle in the horizontal direction, θₚ, is the horizontal deviation angle θₓ described above.

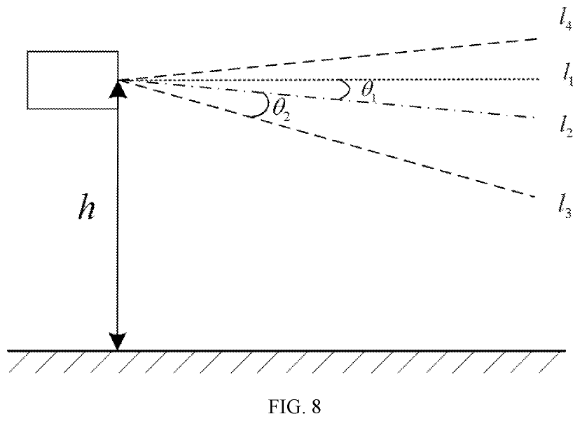

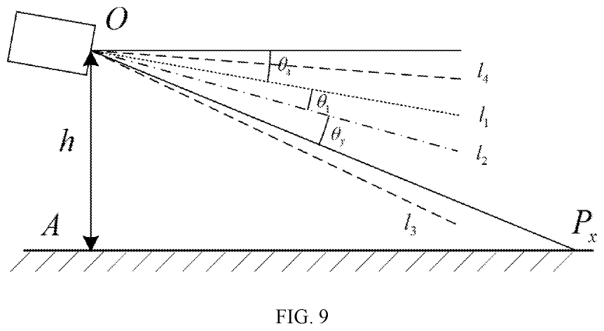

There are two situations in which the photographing apparatus is mounted at the nose of the unmanned aerial vehicle. One situation is that the optical axis of the photographing apparatus is not parallel to the axis of the unmanned aerial vehicle, i.e., the photographing apparatus is inclined at a certain angle relative to the axis of the unmanned aerial vehicle. When the unmanned aerial vehicle is hovering, the axis of the unmanned aerial vehicle is parallel to the horizontal plane, and the optical axis of the photographing apparatus is inclined downwards. In this situation, as shown in FIG. 8, when the unmanned aerial vehicle is hovering in the air, θ₁ is the angle between the axis l₁ of the unmanned aerial vehicle and the optical axis l₂ of the photographing apparatus, θ₂ is the sight angle of the photographing apparatus in the vertical direction as described above. Referring to FIG. 9, when the unmanned aerial vehicle is flying, the attitude of the vehicle body will change. Since the photographing apparatus is fixedly connected to the vehicle body, the vertical field of view of the photographing apparatus also changes. At this time, the angle between the axis of the unmanned aerial vehicle and the horizontal plane is θ₄ which can be measured by the inertial measurement unit of the unmanned aerial vehicle. As shown in FIG. 9, the direction of reference point relative to the unmanned aerial vehicle in the vertical direction is αₚ=(θ₁+θ₄+θₓ). The other situation is that the optical axis of the photographing apparatus is parallel to the axis of the unmanned aerial vehicle, and the direction of reference point relative to the unmanned aerial vehicle in the vertical direction is αₚ=(θ₄+θₓ).

When the photographing apparatus is connected to the body of the unmanned aerial vehicle via a gimbal used to carry the photographing apparatus, the attitude of the photographing apparatus can be determined based on the attitude of the gimbal. The direction of the reference point relative to the unmanned aerial vehicle in the horizontal direction is θₚ=(θₓ+θ₅), where θ₅ is the angle by which the photographing apparatus deviates from the nose in the horizontal direction, and θ₅ can be determined based on the attitude of the gimbal and/or the attitude of the unmanned aerial vehicle. The direction of the reference point relative to the unmanned aerial vehicle in the vertical direction is αₚ=(θ_{y}+θ₆), where θ₆ is the angle of the photographing apparatus deviating from the horizontal plane in the vertical direction, and θ₆ can be determined based on the attitude of the gimbal and/or the attitude of the unmanned aerial vehicle.

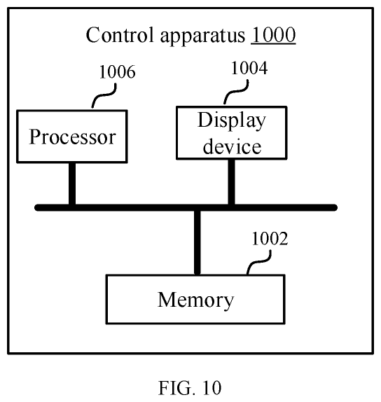

The embodiments of the present disclosure provide a control apparatus. FIG. 10 is a structural diagram of a control apparatus 1000 consistent with the present disclosure. The control apparatus 1000 can perform a method consistent with the disclosure, such as one of the above-described example control methods. As shown in FIG. 10, the apparatus 1000 includes a memory 1002, a display device 1004, and a processor 1006.

The processor 1006 may be a central processing unit (CPU). The processor 1006 may also be a general-purpose processor, a digital signal processor (DSP), an application specific integrated circuit (ASIC), a field-programmable gate array (FPGA) or other programmable logic device, a discrete gate or transistor logic device, a discrete hardware component, etc. The general-purpose processor may be a microprocessor or any appropriate processor.

The memory 1002 is configured to store program codes.

In some embodiments, the processor 1006 is configured to call the program codes to provide an image on the display device 1004, where the image is an image of an environment captured by a photographing apparatus provided at an unmanned aerial vehicle; determine a position of a selected point in the image in response to a point selection operation on the image by a user; and generate a waypoint for the unmanned aerial vehicle or mark an obstacle in the environment according to the position of the selected point in the image.

In some embodiments, the processor 1006 is further configured to generate a route according to the waypoint, and control the unmanned aerial vehicle to fly according to the route.

In some embodiments, the processor 1006 is further configured to control the unmanned aerial vehicle to avoid the marked obstacle during the flight of the unmanned aerial vehicle.

In some embodiments, the processor 1006 is further configured to generate a route that avoids the obstacle according to the marked obstacle, and control the unmanned aerial vehicle to fly according to the route.

In some embodiments, when the processor 1006 generates a waypoint for the unmanned aerial vehicle or mark an obstacle in the environment according to the position of the selected point in the image, the processor 1006 specifically determines the position information of the waypoint of the unmanned aerial vehicle according to the position of the selected point in the image, and generates the waypoint for the unmanned aerial vehicle according to the position information of the waypoint of the unmanned aerial vehicle; or determines the position information of the obstacle in the environment according to the position of the selected point in the image, and mark the obstacle in the environment according to the position information of the obstacle in the environment.

In some embodiments, when the processor 1006 determines the position information of the waypoint of the unmanned aerial vehicle or the position information of the obstacle in the environment according to the position of the selected point in the image, the processor 1006 specifically determines the direction of the reference point in the environment relative to the unmanned aerial vehicle according to the position of the selected point in the image, determines the position information of the reference point according to the direction and the position information of the unmanned aerial vehicle, and determines the position information of the waypoint of the unmanned aerial vehicle or the position information of the obstacle in the environment according to the position information of the reference point.

In some embodiments, when the processor 1006 determines the position information of the reference point according to the direction and the position information of the unmanned aerial vehicle, the processor 1006 specifically determines the relative height between the reference point and the unmanned aerial vehicle, and determines the position information of the reference point according to the relative height, the direction, and the position information of the unmanned aerial vehicle.

In some embodiments, the relative height is determined based on the height information output by an altitude sensor carried by the unmanned aerial vehicle.

In some embodiments, when the processor 1006 determines the position of the reference point relative to the unmanned aerial vehicle according to the position of the selected point in the image, the processor 1006 specifically determines the direction of the reference point relative to the unmanned aerial vehicle according to the position of the selected point in the image and the attitude of the photographing apparatus.

In some embodiments, when the processor 1006 determines the direction of the reference point relative to the unmanned aerial vehicle according to the position of the selected point in the image and the attitude of the photographing apparatus, the processor 1006 specifically determines the angle by which the direction of the reference point relative to the unmanned aerial vehicle deviates from the attitude of the photographing apparatus according to the position of the selected point in the image, and determines the direction of the reference point relative to the unmanned aerial vehicle according to the angle and the attitude of the photographing apparatus.

In some embodiments, the attitude of the photographing apparatus is determined based on the attitude of the unmanned aerial vehicle or the attitude of a gimbal used to carry the photographing apparatus, where the gimbal is arranged at the body of the unmanned aerial vehicle.

In addition, the embodiments of the present disclosure also provide a control terminal for the unmanned aerial vehicle. The control terminal includes the control apparatus described above. The control terminal includes one or more of a remote control, a smart phone, a wearable device, and a laptop.

The embodiments of the present disclosure provide a computer readable storage medium where a computer program is stored. When the computer program is executed by a processor, a method consistent with the disclosure, such as one of the example methods described above, is implemented.

Further, it is understood that any process or method description in the flow chart or described in other manners herein can be understood as representing a module, segment, or some of the codes that include one or more executable instructions for implementing steps of a particular logical function or process. The scope of the embodiments of the present disclosure can include additional implementations, in which the function may not be performed in the order shown or discussed, including in a substantially simultaneous manner or in a reversed order, depending on the functions involved. This should be understood by those skilled in the technical field of the present disclosure.

The logic and/or steps represented in the flow chart or described in other manners herein, for example, can be considered as a sequenced list of executable instructions for implementing logic functions, and can be embodied in any computer readable medium for use by or in combination with an instruction execution system, apparatus, or device (such as a computer-based system, system including processors, or other system that can call and execute instructions from an instruction execution system, apparatus, or device). In the context of this specification, a “computer readable medium” can be any device that can contain, store, communicate, propagate, or transmit a program for use by or in combination with the instruction execution system, apparatus, or device. More specific examples (non-exhaustive list) of computer readable media include the following: an electrical connection (electronic device) with one or more wiring, a portable computer disk case (magnetic device), a random access memory (RAM), a read only memory (ROM), an erasable and editable read only memory (EPROM or flash memory), an optical fiber device, and a portable compact disk read only memory (CDROM). In addition, the computer readable medium may even be paper or other suitable medium on which the program can be printed, as the program may be electronically obtained, for example, by optical scanning of the paper or other medium, followed by editing, interpreting, or other suitable processing methods when necessary, and then stored in the computer memory.

It is understood that each part of the present disclosure can be implemented by hardware, software, firmware or a combination thereof. In the embodiments described above, multiple processes or methods can be implemented by software or firmware stored in a memory and executed by a suitable instruction execution system. For example, if implemented by hardware, as in another embodiment, it can be implemented by any one or a combination of the following technologies: a discrete logic circuit with a logic gate circuit used to implement logic functions on a data signal, an application specific integrated circuit with an appropriate combinational logic gate circuit, a programmable gate array (PGA), a field programmable gate array (FPGA), etc.

One of ordinary skill in the art can understand that all or part of the processes in the method of the embodiments described above can be implemented by a program instructing relevant hardware, and the program can be stored in a computer readable storage medium. When the program is executed, one or more of the processes in the method of the embodiments can be performed.

In addition, the functional units in various embodiments of the present disclosure may be integrated into one processing module, or may exist alone physically, or may be integrated into one module by two or more units. The integrated modules can be implemented in the form of hardware or software functional modules. The integrated module can also be stored in a computer readable storage medium if implemented in the form of a software functional module and sold or used as an independent product.

The storage medium described above may be a read-only memory, a magnetic disk or an optical disk, etc.

The above are only some embodiments of the present disclosure and are not used to limit the present disclosure. For those skilled in the art, the present disclosure can have various modifications and changes. Any modification, equivalent replacement, improvement, etc. made within the spirit and principle of the present disclosure should be included within the protection scope of the present disclosure.

What is claimed is:

1. A control method comprising:
providing an image on a display device, the image being an image of an environment captured by a photographing apparatus provided at an unmanned aerial vehicle;
in response to a point selection operation on the image by a user, determining a position of a selected point in the image; and
generating a waypoint for the unmanned aerial vehicle or marking an obstacle within the environment according to the position of the selected point in the image.

2. The method of claim 1, further comprising:
generating a route according to the waypoint; and
controlling the unmanned aerial vehicle to fly according to the route.

3. The method of claim 1, further comprising:
controlling the unmanned aerial vehicle to avoid the obstacle during flight of the unmanned aerial vehicle.

4. The method of claim 1, further comprising:
generating a route that avoids the obstacle; and
controlling the unmanned aerial vehicle to fly according to the route.

5. The method of claim 1, wherein generating the waypoint or marking the obstacle includes:
determining position information of the waypoint according to the position of the selected point in the image and generating the waypoint according to the position information of the waypoint; or
determining position information of the obstacle according to the position of the position of the selected point in the image and marking the obstacle in the environment according to the position information of the obstacle in the environment.

6. The method of claim 5, wherein determining the position information of the waypoint or the position information of the obstacle according to the position of the selected point in the image includes:
determining a direction of a reference point in the environment relative to the unmanned aerial vehicle according to the position of the selected point in the image;
determining position information of the reference point according to the direction and position information of the unmanned aerial vehicle; and
determining the position information of the waypoint or the position information of the obstacle according to the position information of the reference point.

7. The method of claim 6, wherein determining the position information of the reference point according to the direction and the position information of the unmanned aerial vehicle includes:
determining a relative height between the reference point and the unmanned aerial vehicle; and
determining the position information of the reference point according to the relative height, the direction, and the position information of the unmanned aerial vehicle.

8. The method of claim 7, wherein determining the relative height includes determining the relative height based on height information output by an altitude sensor of the unmanned aerial vehicle.

9. The method of claim 6, wherein determining the direction of the reference point relative to the unmanned aerial vehicle includes determining the direction of the reference point relative to the unmanned aerial vehicle according to the position of the selected point in the image and an attitude of the photographing apparatus.

10. The method of claim 9, wherein determining the direction of the reference point relative to the unmanned aerial vehicle according to the position of the selected point in the image and the attitude of the photographing apparatus includes:
determining a deviation angle by which the direction of the reference point relative to the unmanned aerial vehicle deviates from the attitude of the photographing apparatus according to the position of the selected point in the image; and
determining the direction of the reference point relative to the unmanned aerial vehicle according to the deviation angle and the attitude of the photographing apparatus.

11. The method of claim 9, further comprising:
determining the attitude of the photographing apparatus based on at least one of an attitude of the unmanned aerial vehicle or an attitude of a gimbal provided at the unmanned aerial vehicle and carrying the photographing apparatus.

12. A control apparatus comprising:
a display device; and
a processor configured to:
provide an image on the display device, the image being an image of an environment captured by a photographing apparatus provided at an unmanned aerial vehicle;
in response to a point selection operation on the image by a user, determine a position of a selected point in the image; and
generate a waypoint for the unmanned aerial vehicle or mark an obstacle within the environment according to the position of the selected point in the image.

13. The apparatus of claim 12, wherein the processor is further configured to:
generate a route according to the waypoint; and
control the unmanned aerial vehicle to fly according to the route.

14. The apparatus of claim 12, wherein the processor is further configured to control the unmanned aerial vehicle to avoid the obstacle during flight of the unmanned aerial vehicle.

15. The apparatus of claim 12, wherein the processor is further configured to:
generate a route that avoids the obstacle; and
control the unmanned aerial vehicle to fly according to the route.

16. The apparatus of claim 12, wherein the processor is further configured to:
determine position information of the waypoint according to the position of the selected point in the image and generate the waypoint according to the position information of the waypoint; or
determine position information of the obstacle according to the position of the selected point in the image and mark the obstacle in the environment according to the position information of the obstacle in the environment.

17. The apparatus of claim 16, wherein the processor is further configured to:
determine a direction of a reference point in the environment relative to the unmanned aerial vehicle according to the position of the selected point in the image;
determine position information of the reference point according to the direction and position information of the unmanned aerial vehicle; and
determine the position information of the waypoint or the position information of the obstacle according to the position information of the reference point.

18. The apparatus of claim 17, wherein the processor is further configured to:
determine a relative height between the reference point and the unmanned aerial vehicle; and
determine the position information of the reference point according to the relative height, the direction, and the position information of the unmanned aerial vehicle.

19. The apparatus of claim 17, wherein the processor is further configured to determine the direction of the reference point relative to the unmanned aerial vehicle according to the position of the selected point in the image and an attitude of the photographing apparatus.

20. The apparatus of claim 19, wherein the processor is further configured to:
determine a deviation angle by which the direction of the reference point relative to the unmanned aerial vehicle deviates from the attitude of the photographing apparatus according to the position of the selected point in the image; and
determine the direction of the reference point relative to the unmanned aerial vehicle according to the deviation angle and the attitude of the photographing apparatus.
